(19) United States
(12) Patent Application Publication
(10) Pub. No.: US 2026/0070222 A1
(43) Pub. Date: Mar. 12, 2026

(54) Method of Creating Modified Design on Surface, Control System and Robot System

(71) Applicant: ABB Schweiz AG, Baden (CH)

(72) Inventors: Yngve Finnestad, Sandnes (NO); Jakob Trydal, Kvernaland (NO); Andreas Skaar, Bryne (NO)

(21) Appl. No.: 19/105,634

(22) PCT Filed: Aug. 30, 2022
(86) PCT No.: PCT/EP2022/074123

§ 371 Date: Feb. 21, 2025

(51) Int. Cl. B25J 9/16; B05B 13/04; B25J 11/00; B25J 15/00

(52) U.S. Cl. CPC B25J 9/1669; B05B 13/0431; B25J 11/0075; B25J 15/0019

(57) ABSTRACT

A method of creating a modified design on a surface, the method including providing a tool, and an industrial robot configured to perform relative movements; providing a digital model of the surface, the digital model including a candidate profile of the surface; providing a candidate path for the relative movements based on the candidate profile; providing a candidate design to be created on the surface based on the candidate path; determining an actual profile of the surface; providing a modified path for the relative movements based on the actual profile; modifying the candidate design to provide the modified design to be created on the surface based on a deviation between the candidate path and the modified path; and controlling the industrial robot and the tool to create the modified design on the surface using the modified path for the relative movements.

### TECHNICAL FIELD

The present disclosure generally relates to creation of designs on surface. In particular, a method of creating a modified design on a surface using a tool and an industrial robot, a control system for creating a modified design on a surface, and a robot system comprising an industrial robot, a tool and a control system, are provided.

### BACKGROUND

Automotive parts and many other objects may be printed using digital printing. When performing such digital printing, a printhead having an array of nozzles may be carried by an industrial robot and used to apply paint to a surface in a controlled process to form an image on the surface. As the printhead travels along a path, the printhead may deposit lines of the image along the path accordingly. The printhead may be controlled in this way based on a velocity of the industrial robot relative to the object. The velocity can thus be used to determine at which frequency the printhead should print a new line of the image along the path.

DE 102010004496 A1 discloses a method for printing curved workpieces using a robot. Trajectory deviation between a real trajectory and a target trajectory is utilized in real time as a correction signal for controlling print head matrices of a print head arrangement. Corrected pixel-matrices are printed on the workpieces. The document states that the decisive factor is not that the trajectory is corrected, but rather that the correction signal is used for direct control of the ink jet nozzles arranged in the print head matrix.

### SUMMARY

When printing an image on a surface of an object by digital printing, one may rely on a digital model containing a candidate profile of the surface to generate candidate paths for movements of a printhead relative to the surface. The image can then be generated based on the candidate paths to fit the candidate profile.

However, in many situations, an actual profile of the surface deviates from the candidate profile. If the digital printing is controlled based on an assumption that the candidate profile and the actual profile are identic, the image will be distorted when printed on the actual profile.

In order to adapt the image to the actual profile, the image may be regenerated based on the actual profile upon determining that the actual profile deviates from the candidate profile. This process is however time-consuming to an extent that is not acceptable in many implementations.

Although DE 102010004496 A1 provides a solution for correcting printed pixels in real-time if a real trajectory deviates from a target trajectory, the document is silent regarding handling of a situation where an actual profile deviates from a candidate profile.

One object of the invention is to provide an improved method of creating a modified design on a surface.

A further object of the invention is to provide an improved control system for creating a modified design on a surface.

A still further object of the invention is to provide an improved robot system.

These objects are achieved by the method according to appended claim 1, the control system according to appended claim 10, and the robot system according to appended claim 11.

The invention is based on the realization that by modifying a candidate image provided based on a digital model to provide a modified image when an actual profile of a surface deviates from a candidate profile from the digital model, the modified image can be printed on the actual profile in a manner closely conforming to the manner the candidate image is provided relative to the candidate profile, without having to regenerate the image based on the actual profile.

According to a first aspect, there is provided a method of creating a modified design on a surface, the method comprising providing a tool, and an industrial robot configured to perform relative movements between the tool and the surface; providing a digital model of the surface, the digital model comprising a candidate profile of the surface; providing a candidate path for the relative movements based on the candidate profile; providing a candidate design to be created on the surface based on the candidate path; determining an actual profile of the surface; providing a modified path for the relative movements based on the actual profile; modifying the candidate design to provide the modified design to be created on the surface based on a deviation between the candidate path and the modified path; and controlling the industrial robot and the tool to create the modified design on the surface using the modified path for the relative movements.

The method thus adapts to a deviation between the candidate profile and the actual profile by modifying the candidate design to provide the modified design. In this way, a printed image can be manipulated to compensate for a path deviation caused by the actual profile not perfectly corresponding to the candidate profile. By modifying the candidate design to provide the modified design based on a deviation between the candidate path and the modified path, the design can be efficiently adapted to an actual profile not corresponding to the candidate profile. The method thus comprises generating a new path for the relative movements based on the actual profile.

The candidate design may be modified to provide the modified design by stretching, shortening or otherwise changing, e.g. in directions parallel with the relative movements. The modification of the candidate design to provide the modified design may be performed before initiating creation of the modified design on the surface.

The determination of the actual profile may comprise measuring the actual profile. To this end, a line scanner may be used. The digital model may be a CAD (computer-aided design) model.

The tool may be of any type to create the design on the surface. The tool may for example be a digital printhead, such as an inkjet printer.

The industrial robot may comprise a manipulator programmable in three or more axes, such as in six or seven axes. The industrial robot may carry any of the tool and an object having the surface.

The provision of the modified path may comprise modifying the candidate path to provide the modified path. Alternatively, the modified path may be generated based on the actual profile independently of the candidate path.

The candidate design may be a candidate image. In this case, the modified design may be a modified image.

The candidate image may comprise a plurality of pixels. In this case, the modification of the candidate image to provide the modified image may comprise adding one or more pixels to the candidate image or removing one or more pixels from the candidate image.

The one or more pixels may comprise a plurality of pixels arranged in a line of pixels.

The candidate path and the modified path may lie in a common plane. The modification of the candidate design may be made at least partially in this plane. Alternatively, or in addition, the modification of the candidate design may be made in a direction transverse to this plane.

The line of pixels may be transverse to the plane.

The creation of the modified design on the surface may comprise applying a coating medium to the surface. The coating medium may be paint.

The method is however not limited to painting. As one example, the method can also be used to create holes distributed in a particular pattern on a surface, for example by laser cutting.

The surface may be a first surface, the modified path may be a first modified path, and the modified design may be a first modified design. In this case, the method may further comprise providing a second surface; determining a second actual profile of the second surface; providing a second modified path for the relative movements based on the second actual profile; modifying the candidate design to provide a second modified design to be created on the second surface based on a deviation between the candidate path and the second modified path; and controlling the industrial robot and the tool to create the second modified design on the second surface using the second modified path for the relative movements.

According to a second aspect, there is provided a control system for creating a modified design on a surface, the control system comprising at least one data processing device and at least one memory having at least one computer program stored thereon, the at least one computer program comprising program code which, when executed by the at least one data processing device, causes the at least one data processing device to perform the steps of providing a digital model of the surface, the digital model comprising a candidate profile of the surface; providing a candidate path for relative movements between a tool and the surface based on the candidate profile; providing a candidate design to be created on the surface based on the candidate path; determining an actual profile of the surface; providing a modified path for the relative movements based on the actual profile; modifying the candidate design to provide the modified design to be created on the surface based on a deviation between the candidate path and the modified path; and controlling an industrial robot and the tool to create the modified design on the surface using the modified path for the relative movements.

The at least one computer program may further comprise program code which, when executed by the at least one data processing device, causes the at least one data processing device to perform, or command performance of, any step of the first aspect.

According to a third aspect, there is provided a robot system comprising the industrial robot, the tool and the control system according to the second aspect. The industrial robot, the tool and the control system may be of any type according to the present disclosure.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a robot system comprising an industrial robot, a tool and an object having a surface;

FIG. 2a: schematically represents a side view of a candidate profile of a digital model of the surface;

FIG. 2b: schematically represents a top view of the candidate profile;

FIG. 3a: schematically represents a side view of a candidate path for the tool and a candidate design on the candidate profile;

FIG. 3b: schematically represents a top view of the candidate design on the candidate profile;

FIG. 4a: schematically represents a side view of the candidate design on an actual profile of the surface;

FIG. 4b: schematically represents a top view of the candidate design on the actual profile;

FIG. 5: schematically represents a side view of a modified path for the tool;

FIG. 6: schematically represents a deviation between the candidate path and the modified path;

FIG. 7a: schematically represents a side view of the modified path and a modified design on the actual profile;

FIG. 7b: schematically represents a top view of the modified design on the actual profile;

FIG. 8: schematically represents a side view of the robot system and a further object comprising a surface;

FIG. 9a: schematically represents a side view of the candidate design on an actual profile of the surface in FIG. 8;

FIG. 9b: schematically represents a top view of the candidate design on the actual profile in FIG. 9a;

FIG. 10: schematically represents a side view of a further example of a modified path for the tool;

FIG. 11: schematically represents a deviation between the candidate path and the modified path in FIG. 10;

FIG. 12a: schematically represents a side view of the modified path in FIG. 10 and a modified design on the actual profile in FIGS. 9a and 9b;

FIG. 12b: schematically represents a top view of the modified design on the actual profile in FIG. 12a;

FIG. 13: schematically represents a top view of a further example of a candidate design;

FIG. 14: schematically represents a top view of a further example of a modified design based on a modification of the candidate design in FIG. 13;

FIG. 15: schematically represents a top view of a further example of a modified design based on a modification of the candidate design in FIG. 13; and

FIG. 16: schematically represents a block diagram outlining general steps of a method.

### DETAILED DESCRIPTION

In the following, a method of creating a modified design on a surface using a tool and an industrial robot, a control system for creating a modified design on a surface, and a robot system comprising an industrial robot, a tool and a control system, will be described. The same or similar reference numerals will be used to denote the same or similar structural features.

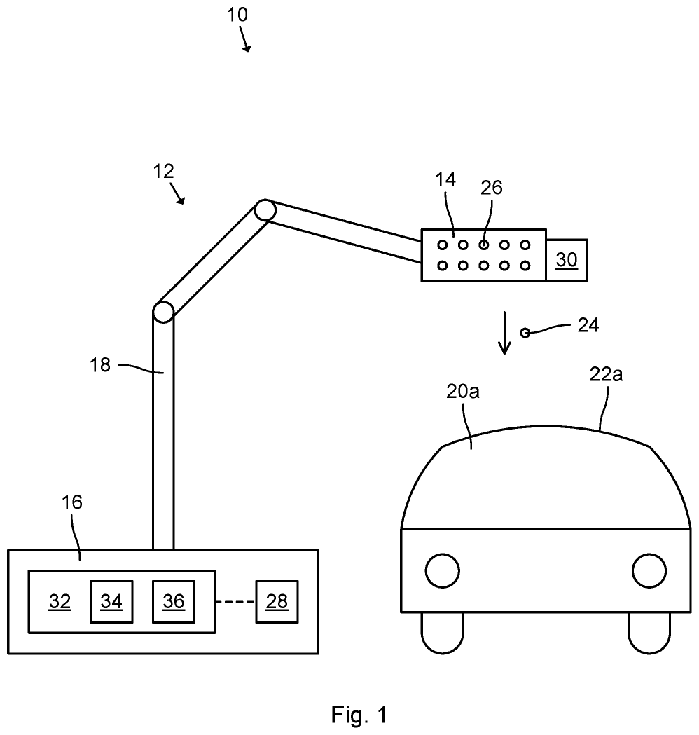

FIG. 1 schematically represents a side view of a robot system 10. The robot system 10 comprises an industrial robot 12 and a digital printhead 14. The printhead 14 is one example of a tool according to the present disclosure.

The industrial robot 12 of this example comprises a base 16 and a manipulator 18 movable relative to the base 16. The manipulator 18 may be movable in at least three axes, such as in six or seven axes, relative to the base 16.

FIG. 1 further shows an object 20a, here exemplified as a car. The object 20a comprises a surface 22a, here exemplified as a roof surface of the car. An object according to the present disclosure is however not limited to cars and a surface 22a according to the present disclosure is not limited to surface of car bodies.

In this example, the object 20a is stationary and the industrial robot 12 carries and moves the printhead 14 relative to the stationary object 20a. The printhead 14 is here arranged at a distal end of the manipulator 18. As an alternative, printhead 14 may be stationary and the industrial robot 12 may carry and move the object 20a relative to the stationary printhead 14. In any case, the industrial robot 12 is configured to perform relative movements between the printhead 14 and the object 20a.

The printhead 14 is configured to apply paint 24 to the surface 22a by digital printing. The paint 24 is one example of a coating medium according to the present disclosure. In this way, the printhead 14 can create a modified design on the surface 22a. The printhead 14 comprises a plurality of nozzles 26. The nozzles 26 are controlled individually. In this example, the nozzles 26 are arranged in a matrix comprising rows and columns. The robot system 10 further comprises a supply unit 28. The supply unit 28 is configured to supply paint 24 to the printhead 14.

The robot system 10 further comprises a scanner 30. The scanner 30 is here carried by the industrial robot 12.

The robot system 10 further comprises a control system 32. The control system 32 comprises a data processing device 34 and a memory 36. The memory 36 has a computer program stored thereon. The computer program comprises program code which, when executed by the data processing device 34, causes the data processing device 34 to perform, or command performance of, various steps as described herein. In this example, the control system 32 controls the industrial robot 12, the supply unit 28, the printhead 14 and the scanner 30.

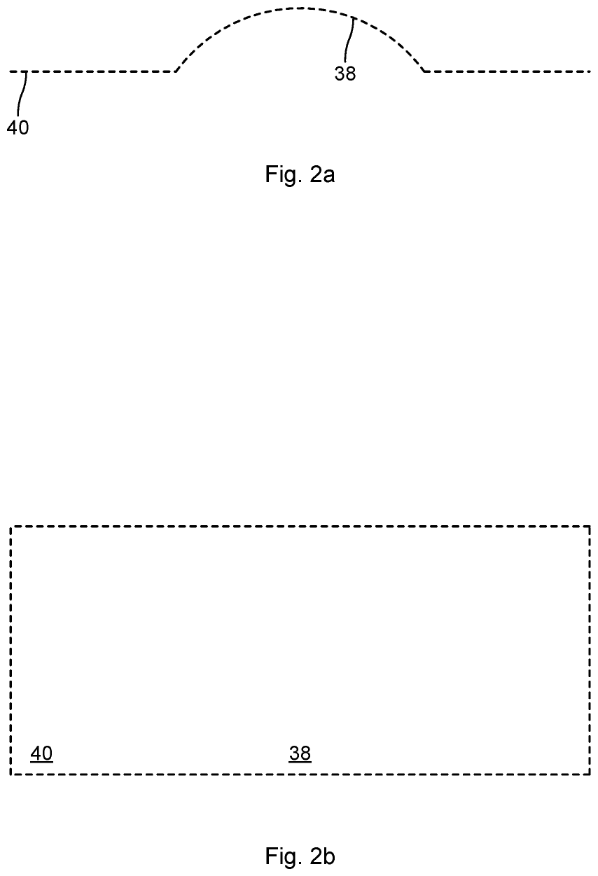

FIG. 2a schematically represents a side view of a candidate profile 38 of a digital model 40 of the surface 22a, and FIG. 2b schematically represents a top view of the candidate profile 38. The surface 22a and any other parts of the object 20a may for example be modelled with CAD to provide the digital model 40. The digital model 40 of the surface 22a containing the candidate profile 38 may be provided in the control system 32. As shown in FIG. 2a, the candidate profile 38 comprises a curved section.

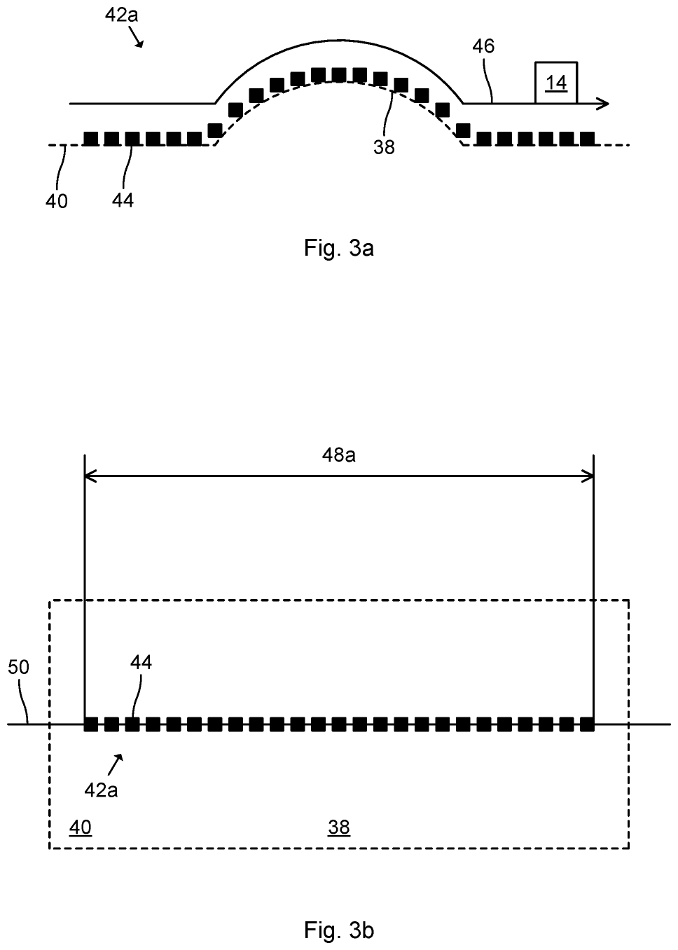

FIG. 3a schematically represents a side view of the candidate profile 38 and a candidate image 42a thereon, and FIG. 3b schematically represents a top view of the candidate profile 38 and the candidate image 42a thereon. The candidate image 42a may be of a wide range of different types for being printed on the surface 22a. The candidate image 42a may for example be a stripe on the roof of the object 20a. The candidate image 42a comprises a plurality of pixels 44.

FIG. 3a further shows a candidate path 46 for the printhead 14. The candidate path 46 is a path for relative movements between the printhead 14 and the object 20a when printing the candidate image 42a on the surface 22a. In this example, the candidate path 46 is a path for the manipulator 18 to follow to move the printhead 14 relative to the surface 22a. The candidate path 46 may for example be set at a fixed distance above the candidate profile 38. In FIG. 3b, a candidate length 48a of the candidate image 42a on the candidate profile 38 is shown.

The control system 32 is configured to provide the candidate path 46 based on the candidate profile 38. The control system 32 is also configured to provide the candidate image 42a based on the candidate path 46. The candidate image 42a may for example be provided by modifying a source image for a flat surface based on the candidate path 46.

FIG. 3b further shows a plane 50. The candidate path 46 is here provided in the plane 50. FIG. 3a is a view of this plane 50.

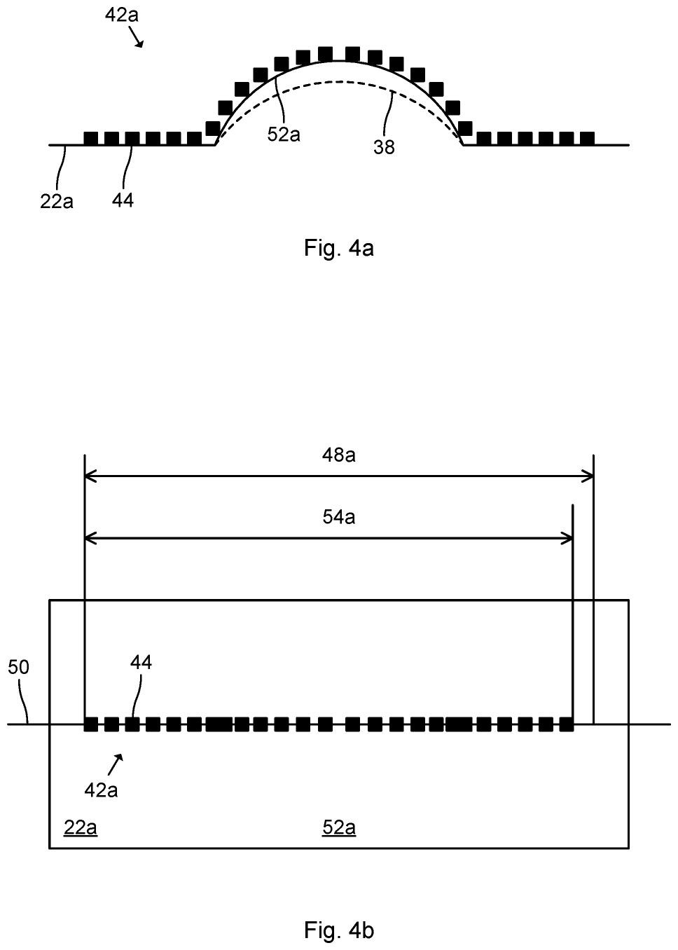

FIG. 4a schematically represents a side view of the candidate image 42a on an actual profile 52a of the surface 22a, and FIG. 4b schematically represents a top view of the candidate image 42a on the actual profile 52a. As shown in FIG. 4a, the physical actual profile 52a deviates from the candidate profile 38 from the digital model 40. The reasons for this deviation may be many, such as acceptable variations within tolerances. The actual profile 52a here has a steeper curved section than the candidate profile 38.

In order to determine the actual profile 52a, the industrial robot 12 moves along the surface 22a and measures the actual profile 52a using the scanner 30. To this end, the industrial robot 12 may for example move along the candidate path 46. For a plurality of positions along the candidate path 46, the scanner 30 measures a distance to the surface 22a. The actual profile 52a can then be determined by the measured distances to the surface 22a by the scanner 30. The actual profile 52a may however be determined in alternative ways.

If the frequency of printhead 14 is controlled based on a velocity of the industrial robot 12 relative to the object 20a, the deviations between the actual profile 52a and the candidate profile 38 will cause the candidate image 42a to end too soon if printed on the actual profile 52a. Thus, the printing of the candidate image 42a on the actual profile 52a will be compressed in comparison with the provision of the candidate image 42a on the candidate profile 38.

As shown in FIGS. 4a and 4b, if the candidate image 42a would be printed on the actual profile 52a, the candidate image 42a would have an erroneous length 54a that is shorter than the candidate length 48a due to the deviations between the actual profile 52a and the candidate profile 38. Thus, the candidate image 42a would be deteriorated due to the deviations.

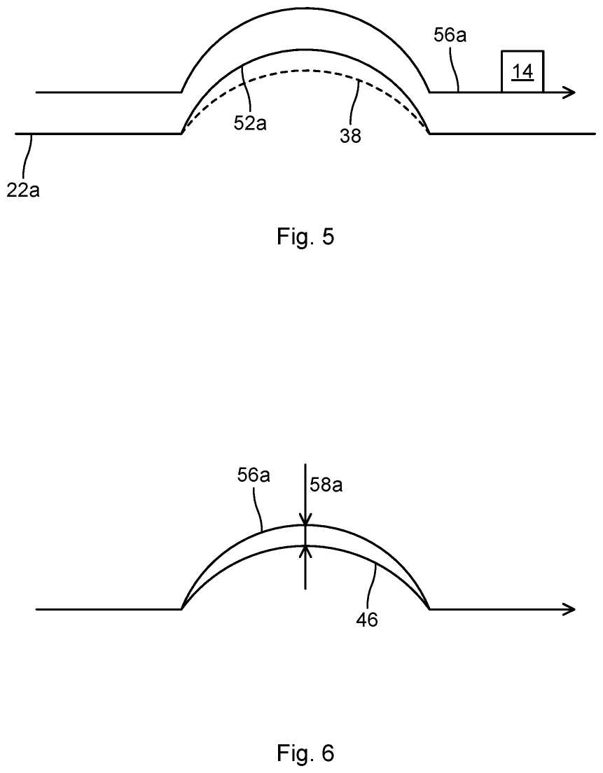

FIG. 5 schematically represents a side view of a modified path 56a for the printhead 14. The control system 32 is configured to determine the modified path 56a based on the actual profile 52a. The modified path 56a may for example be set at a fixed distance above the actual profile 52a. The measured distances to the surface 22a can thus be used to create the new, modified path 56a for the printhead 14.

FIG. 6 schematically represents a deviation 58a between the candidate path 46 and the modified path 56a. As shown, the modified path 56a deviates from the candidate path 46, here for a relatively short segment. The control system 32 may determine the deviation 58a for a plurality of positions along the modified path 56a.

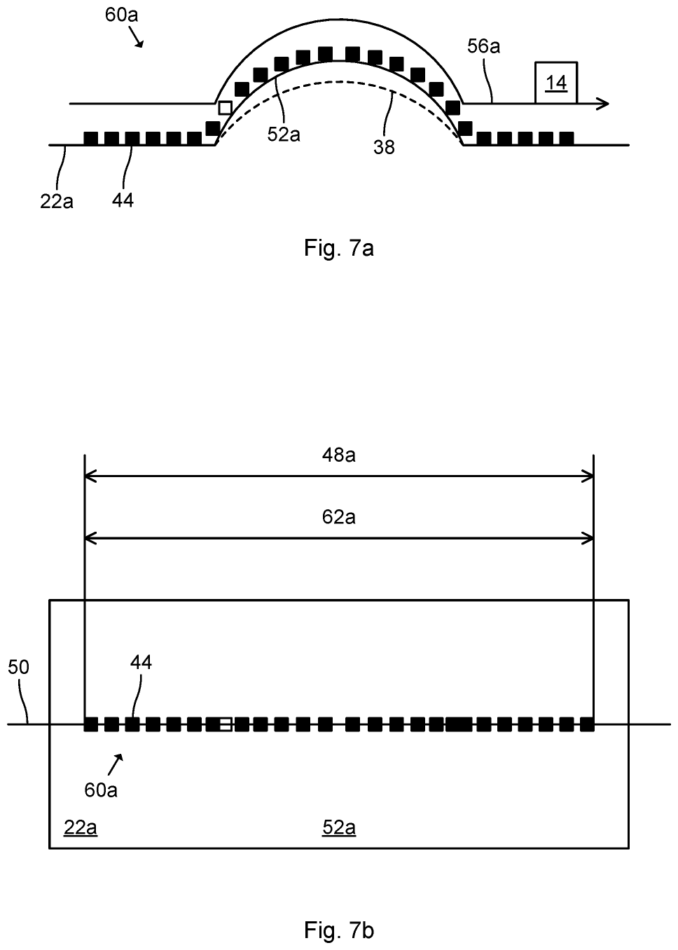

FIG. 7a schematically represents a side view of the modified path 56a and a modified image 60a on the actual profile 52a, and FIG. 7b schematically represents a top view of the modified image 60a on the actual profile 52a. The modified image 60a is provided by the control system 32 by modifying the candidate image 42a based on the deviation 58a between the candidate path 46 and the modified path 56a. In this way, the industrial robot 12 can adapt to the deviation 58a by image compensation.

In this example, one pixel 44 shown without filling in FIGS. 7a and 7b has been added to the candidate image 42a to provide the modified image 60a. The addition of the pixel 44 is made since the erroneous length 54a was shorter than the candidate length 48a (FIG. 4b). The candidate image 42a may thus be modified to provide the modified image 60a such that a length of the modified image 60a provided on the actual profile 52a matches a length of the candidate image 42a provided on the candidate profile 38, as seen from above the actual profile 52a and the candidate profile 38, respectively.

In FIGS. 7a and 7b, the modified image 60a is stretched in comparison with the candidate image 42a. As shown in FIG. 7b, when the modified image 60a is printed on the actual profile 52a using the modified path 56a, the modified image 60a has a modified length 62a in a main extension direction of the surface 22a that equals the candidate length 48a in the main direction of the surface 22a. Thus, the modified image 60a can be printed on the actual profile 52a without distortions. That is, the appearance of the modified image 60a on the actual profile 52a corresponds to the appearance of the candidate image 42a on the candidate profile 38. The robot system 10 then performs the printing of the modified image 60a on the object 20a using the modified path 56a.

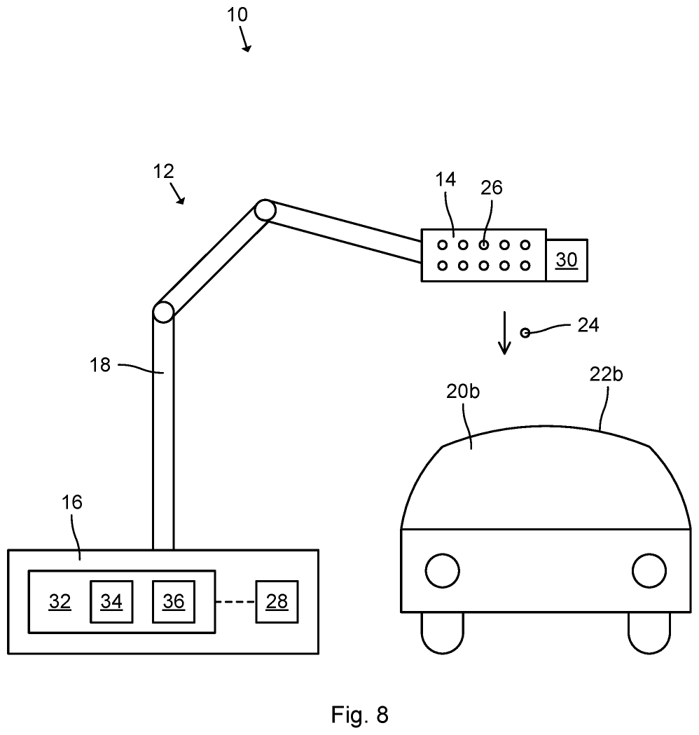

FIG. 8 schematically represents a side view of the robot system 10 and a further object 20b comprising a surface 22b. Although both the first surface 22a and the second surface 22b are modelled by the candidate profile 38 of the digital model 40, none of the first surface 22a and the second surface 22b perfectly matches the candidate profile 38. Moreover, the first surface 22a and the second surface 22b also deviate from each other.

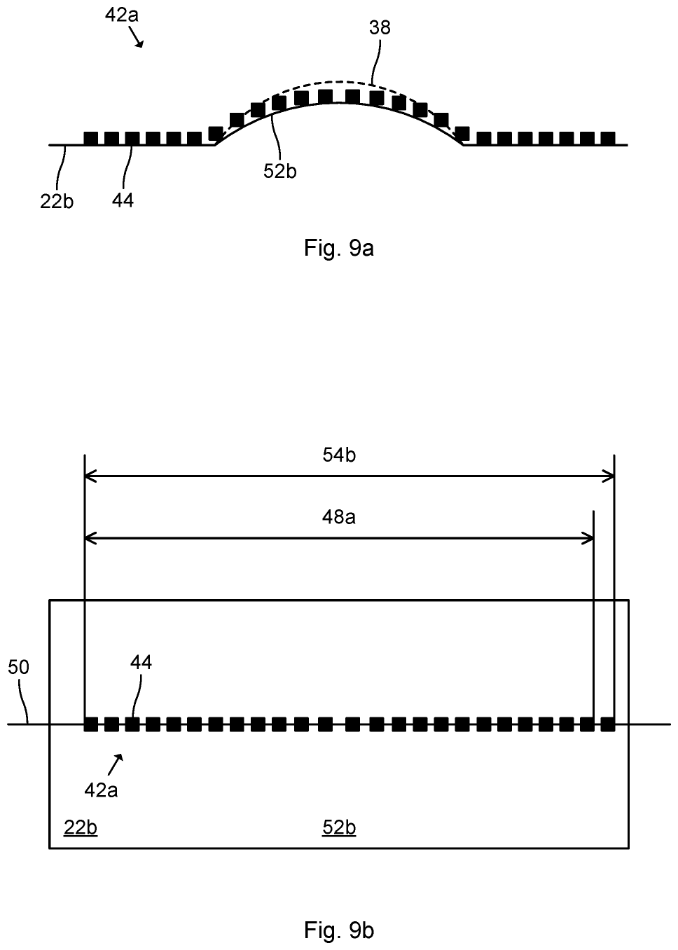

FIG. 9a schematically represents a side view of the candidate image 42a on a second actual profile 52b of the second surface 22b, and FIG. 9b schematically represents a top view of the candidate image 42a on the second actual profile 52b. As shown in FIG. 9a, the physical second actual profile 52b deviates from the candidate profile 38. The second actual profile 52b here has a flatter curved section than the candidate profile 38.

In this example, the deviations between the second actual profile 52b and the candidate profile 38 will cause the candidate image 42a to end too late if printed on the second actual profile 52b. Thus, the provision of the candidate image 42a on the second actual profile 52b will be extended in comparison with the provision of the candidate image 42a on the candidate profile 38.

As shown in FIGS. 9a and 9b, if the candidate image 42a would be printed on the second actual profile 52b, the candidate image 42a would have an erroneous length 54b that is longer than the candidate length 48a due to the deviations between the second actual profile 52b and the candidate profile 38. Also in this way, the candidate image 42a would be deteriorated due to the deviations.

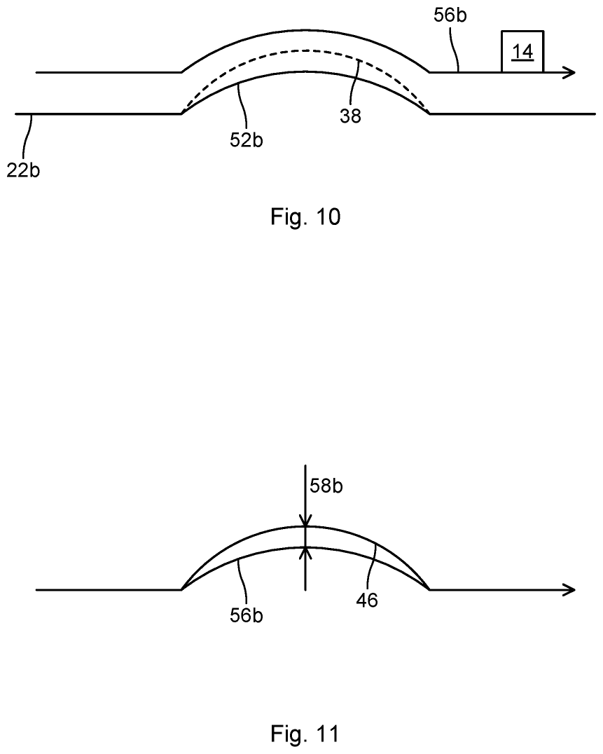

FIG. 10 schematically represents a side view of a second modified path 56b for the printhead 14. The control system 32 is configured to determine the second modified path 56b based on the second actual profile 52b, e.g. in the same manner as the first modified path 56a is determined based on the first actual profile 52a.

FIG. 11 schematically represents a deviation 58b between the candidate path 46 and the second modified path 56b. As shown, the second modified path 56b deviates from the candidate path 46, here for a relatively short segment. The control system 32 may determine the deviation 58b for a plurality of positions along the second modified path 56b.

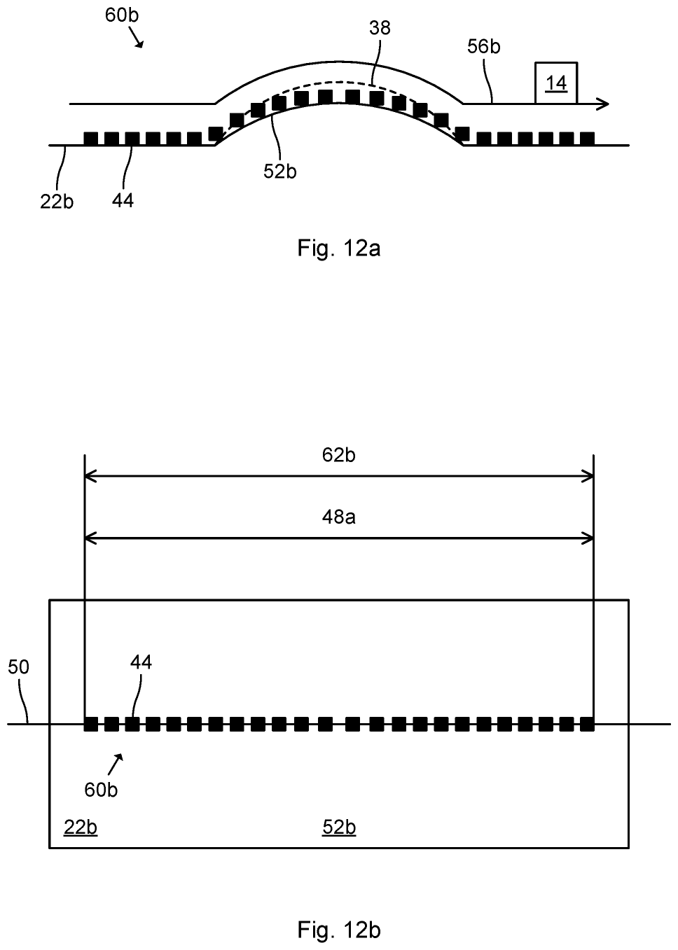

FIG. 12a schematically represents a side view of the second modified path 56b and a modified image 60b on the second actual profile 52b, and FIG. 12b schematically represents a top view of the modified image 60b on the second actual profile 52b. The modified image 60b is provided by the control system 32 by modifying the candidate image 42a based on the deviation 58b between the candidate path 46 and the second modified path 56b.

In this example, one pixel 44 has been removed from the candidate image 42a to provide the modified image 60b. The removal of the pixel 44 is made since the erroneous length 54b was longer than the candidate length 48a (FIG. 9b). Also in this way, the candidate image 42a may thus be modified to provide the modified image 60b such that a length of the modified image 60b provided on the second actual profile 52b matches a length of the candidate image 42a provided on the candidate profile 38, as seen from above the first actual profile 52a and the candidate profile 38, respectively.

In FIGS. 12a and 12b, the modified image 60b is compressed in comparison with the candidate image 42a. As shown in FIG. 12b, when the modified image 60b is printed on the second actual profile 52b using the second modified path 56b, the modified image 60b has a modified length 62b in a main extension direction of the second surface 22b that equals the candidate length 48a in the main direction of the second surface 22b. Thus, the modified image 60b can be printed on the second actual profile 52b without distortions. That is, the appearance of the modified image 60b on the second actual profile 52b corresponds to the appearance of the candidate image 42a on the candidate profile 38. The robot system 10 then performs the printing of the modified image 60b on the object 20b using the second modified path 56b. The candidate image 42a can thus be manipulated by adding or removing pixels 44 to compensate for inherent size differences between the first actual profile 52a or 52b and the candidate profile 38.

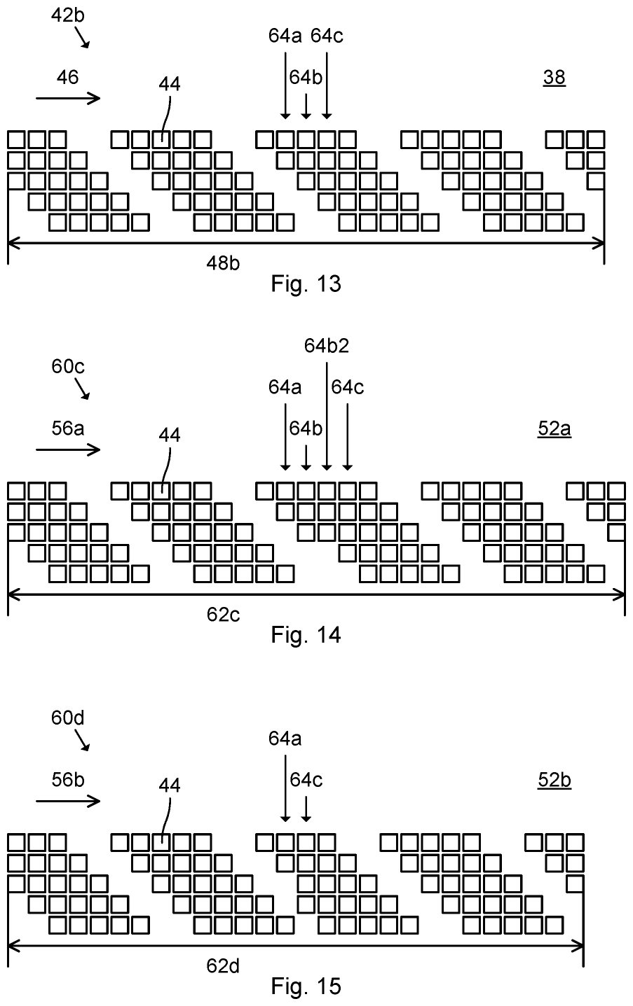

FIG. 13 schematically represents a top view of a further example of a candidate image 42b. The candidate image 42b is provided on the candidate profile 38 in the digital model 40. FIG. 13 further shows the candidate path 46 for the printhead 14. The candidate image 42b comprises a plurality of columns transverse to the candidate path 46. FIG. 13 denotes columns 64a, 64b and 64c. Each column 64a, 64b and 64c comprises a plurality of pixels 44 transverse to the candidate path 46. In FIG. 13, a candidate length 48b of the candidate image 42b on the candidate profile 38 is shown. The candidate images 42a and 42b are examples of candidate designs according to the present disclosure.

FIG. 14 schematically represents a top view of a further example of a modified image 60c. The modified image 60c is provided on the first actual profile 52a. FIG. 14 further shows the first modified path 56a for the printhead 14. The modified image 60c is a modification of the candidate image 42b based on the deviation 58a between the first modified path 56a and the candidate path 46. In FIG. 14, the candidate image 42b has been modified by adding a column 64b2 of pixels 44 between the columns 64b and 64c to provide the modified image 60c. The modified image 60c is thereby extended along the first modified path 56a in comparison with the candidate image 42b. A modified length 62c of modified image 60c along the first modified path 56a is thereby longer than the candidate length 48b of the candidate image 42b along the candidate path 46 to compensate for the deviations between the candidate profile 38 and the first actual profile 52a. The column 64b2 of pixels 44 can be inserted to the candidate image 42b where the deviation 58a between the candidate path 46 and the first modified path 56a is most significant. A plurality of columns may be inserted in this manner.

FIG. 15 schematically represents a top view of a further example of a modified image 60d. The modified image 60d is provided on the second actual profile 52b. FIG. 15 further shows the second modified path 56b for the printhead 14. The modified image 60d is a modification of the candidate image 42b based on the deviation 58b between the second modified path 56b and the candidate path 46. In FIG. 15, the candidate image 42b has been modified by removing the column 64b of pixels 44 to provide the modified image 60d. The modified image 60d is thereby compressed along the second modified path 56b in comparison with the candidate image 42b. A modified length 62d of the modified image 60d along the second modified path 56b is thereby shorter than the candidate length 48b of the candidate image 42b along the candidate path 46 to compensate for the deviations between the candidate profile 38 and the second actual profile 52b. A column can be removed from the candidate image 42b where the deviation 58b between the candidate path 46 and the second modified path 56b is most significant. A plurality of columns may be removed in this manner.

The method of modifying the candidate image 42a and 42b to provide the modified image 60a-60d enables the modified image 60a-60d to be generated without having to modify the digital model 40 and without having to completely generate a new image. The modified images 60a-60d are examples of modified designs according to the present disclosure. The columns 64a, 64b, 64b2 and 64c are examples of lines according to the present disclosure. One, several or all of the columns 64a, 64b, 64b2 and 64c may also be referred to with reference numeral “64”.

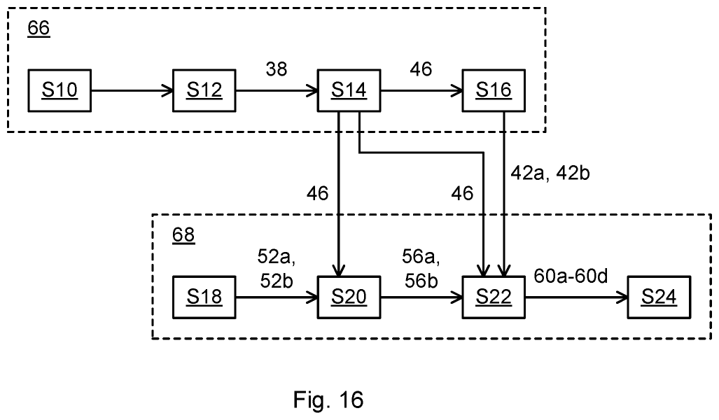

FIG. 16 schematically represents a block diagram outlining general steps of the method of printing images on the surface 22a and 22b. The method comprises a step S10 of providing the printhead 14 and the industrial robot 12. The method further comprises a step S12 of providing the digital model 40 containing the candidate profile 38 of the surface 22a and 22b. The method further comprises a step S14 of providing the candidate path 46 for relative movements between the printhead 14 and the surface 22a and 22b based on the candidate profile 38. The method further comprises a step S16 of providing the candidate image 42a and 42b to be created on the surface 22a and 22b based on the candidate path 46. The steps S10, S12, S14 and S16 in a first box 66 may be performed once for each digital model 40.

The method further comprises a step S18 of determining the actual profile 52a and 52b of the surface 22a and 22b. The method further comprises a step S20 of providing a modified path 56a and 56b for the relative movements based on the actual profile 52a and 52b. The method further comprises a step S22 of modifying the candidate image 42a and 42b to provide the modified image 60a-60d to be printed on the surface 22a and 22b based on the deviation 58a and 58b between the candidate path 46 and the modified path 56a and 56b. The method further comprises a step S24 of controlling, by the control system 32, the industrial robot 12 and the printhead 14 to print the modified image 60a-60d on the surface 22a and 22b using the modified path 56a and 56b for the relative movements. The steps S18, S20, S22 and S24 in a second box 68 may be performed once for each object 20a and 20b to be painted or once for each surface 22a and 22b to be painted.

The method enables efficient printing of an existing image using a modified path 56, and a time consuming generation of a new image based on the actual profile 52a and 52b to be avoided. The method contributes to time savings and makes the robot system 10 more flexible. The method has been tested by the inventors and proven to function as described herein.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of creating a modified design on a surface, the method comprising:
providing a tool, and an industrial robot configured to perform relative movements between the tool and the surface;
providing a digital model of the surface, the digital model including a candidate profile of the surface;
providing a candidate path for the relative movements based on the candidate profile;
providing a candidate design to be created on the surface based on the candidate path;
determining an actual profile of the surface;
providing a modified path for the relative movements based on the actual profile;
modifying the candidate design to provide the modified design to be created on the surface based on a deviation between the candidate path and the modified path; and
controlling the industrial robot and the tool to create the modified design on the surface using the modified path for the relative movements.

2. The method according to claim 1, wherein the candidate design is a candidate image, and wherein the modified design is a modified image.

3. The method according to claim 2, wherein the candidate image comprises a plurality of pixels, and wherein the modification of the candidate image to provide the modified image includes adding one or more pixels to the candidate image or removing one or more pixels from the candidate image.

4. The method according to claim 3, wherein the one or more pixels comprises a plurality of pixels arranged in a line of pixels.

5. The method according to claim 1, wherein the candidate path and the modified path lie in a common plane.

6. The method according to claim 5, wherein the line of pixels is transverse to the plane.

7. The method according to claim 1, wherein the creation of the modified design on the surface includes applying a coating medium to the surface.

8. The method according to claim 1, wherein the surface is a first surface, wherein the modified path is a first modified path, wherein the modified design is a first modified design, and wherein the method further comprises:
providing a second surface;
determining a second actual profile of the second surface;
providing a second modified path for the relative movements based on the second actual profile;
modifying the candidate design to provide a second modified design to be created on the second surface based on a deviation between the candidate path and the second modified path; and
controlling the industrial robot and the tool to create the second modified design on the second surface using the second modified path for the relative movements.

9. A control system for creating a modified design on a surface, the control system comprising at least one data processing device and at least one memory having at least one computer program stored thereon, the at least one computer program comprising program code which, when executed by the at least one data processing device, causes the at least one data processing device to perform the steps of:
providing a digital model of the surface, the digital model including a candidate profile of the surface;
providing a candidate path for relative movements between a tool and the surface based on the candidate profile;
providing a candidate design to be created on the surface based on the candidate path;
determining an actual profile of the surface;
providing a modified path for the relative movements based on the actual profile;
modifying the candidate design to provide the modified design to be created on the surface based on a deviation between the candidate path and the modified path; and
controlling an industrial robot and the tool to create the modified design on the surface-using the modified path for the relative movements.

10. A robot system comprising an industrial robot, a tool and a control system for creating a modified design on a surface, the control system including at least one data processing device and at least one memory having at least one computer program stored thereon, the at least one computer program comprising program code which, when executed by the at least one data processing device, causes the at least one data processing device to perform the steps of:
providing a digital model of the surface, the digital model including a candidate profile of the surface;
providing a candidate path for relative movements between a tool and the surface based on the candidate profile;
providing a candidate design to be created on the surface based on the candidate path;
determining an actual profile of the surface;
providing a modified path for the relative movements based on the actual profile;
modifying the candidate design to provide the modified design to be created on the surface based on a deviation between the candidate path and the modified path; and
controlling an industrial robot and the tool to create the modified design on the surface using the modified path for the relative movements.

11. The method according to claim 2, wherein the candidate path and the modified path lie in a common plane.

12. The method according to claim 2, wherein the creation of the modified design on the surface includes applying a coating medium to the surface.

13. The method according to claim 2, wherein the surface is a first surface, wherein the modified path is a first modified path, wherein the modified design is a first modified design, and wherein the method further comprises:
providing a second surface;
determining a second actual profile of the second surface;
providing a second modified path for the relative movements based on the second actual profile;
modifying the candidate design to provide a second modified design to be created on the second surface based on a deviation between the candidate path and the second modified path; and
controlling the industrial robot and the tool to create the second modified design on the second surface using the second modified path for the relative movements.
